(19) United States
(12) Patent Application Publication
(10) Pub. No.: US 2014/0132760 A1
(43) Pub. Date: May 15, 2014

(54) APPARATUS FOR MEASURING LINE WIDTH

(71) Applicant: SHENZHEN CHINA STAR OPTOELECTRONICS TECHNOLOGY CO., LTD., Shenzhen, Guangdong (CN)

(72) Inventor: Yung-Yu Lin, Shenzhen City (CN)

(73) Assignee: Shenzhen China Star Optoelectronics Technology Co., Ltd., Shenzhen, Guangdong (CN)

(21) Appl. No.: 13/806,892

(22) PCT Filed: Nov. 27, 2012
(86) PCT No.: PCT/CN2012/085362

§ 371 Date: Dec. 26, 2012

(30) Foreign Application Priority Data
Nov. 15, 2012 (CN) 201210459757.8

(51) Int. Cl. G01B 11/02

(52) U.S. Cl. CPC G01B 11/02
USPC 348/136

(57) ABSTRACT

The present invention provides an apparatus for measuring line width, for capturing an image of a pattern to be measured. The apparatus for measuring line width includes at least: a first backlight source and a second backlight source, the first backlight source and the second backlight source being disposed respectively under the pattern to be measured and projecting backlight onto the pattern to be measured; an image capturing device, disposed above the pattern to be measured for capturing the image of the pattern. As such, the present invention effectively avoids causing shadows and improves the precision of image capturing of the image capturing device, as well as reduces the number of required light sources to reduce the cost of modification and maintenance of the apparatus for measuring line width.

The present application claims priority of “APPARATUS FOR MEASURING LINE WIDTH”, application number 201210459757.8 submitted to State Intellectual Property Office, People Republic of China dated Nov. 15, 2012.

### BACKGROUND OF THE INVENTION

1. Field of the Invention

The present invention relates to an apparatus for measuring line width, and in particular to a line width measurement apparatus for projecting backlight on the pattern to be measured to prevent shadow on the edge of the pattern to affect image capturing.

2. The Related Arts

As the semiconductor process develops, the integrated circuit elements are smaller and smaller and demand higher accuracy. Therefore, in the semiconductor process, the controlling of critical dimension, such as, line width and line gap of the fine circuit pattern of mask or wafer becomes an important part. In general, the manufacturer uses line width measurement apparatus to measure the critical dimension of the circuit pattern to detect whether the line width and line gap are accurate and not deviated.

Referring to FIG. 1, FIG. 1 is a schematic view showing the line width measurement in known technique. The known technique uses an image capturing device 91 (such as CCD lens) to capture an image of a pattern 92 to be measured, and then uses a PC to process to measure the line width. The image capturing device is usually disposed together with a light source device 90. The light source device 90 provides front lighting from above the pattern 92 so that the image capturing device can capture clear images.

As the size of semiconductor reduces, the tolerance of errors in line width in the process also becomes smaller. Therefore, the known line width measurement technique shows the following disadvantage in actual application: because the light source device 90 projects the light in a radiation manner vertically on to the pattern 92, the edge of pattern 92 may not be shined by the light source device 90 due to the thickness and a shadow is caused. Referring to FIG. 2, because the line width measurement requires converting a color image to a grey-scale image, which uses PC to perform the integral computation for conversion. When the shadow is converted to grey-scale value, a slant line appears. In other words, the edge of the pattern will be interfered by the shadow so that the accurate capturing and definition is impossible. As such, the shadow will affect the accuracy of image capturing to generate error in line width measurement.

Therefore, another known technique is used to avoid the shadow in the pattern to be measured. However, this known technique requires providing more front lighting for patterns with cross-section other than square so that the shadow on the edge of the patterns can be avoided. For example, in known technique, there is a solution of using a main light source and a plurality of compensation light sources for accurately capturing the image of the patterns to be measured.

The problem of the known technique is: for patterns with different projection lengths at the top and bottom ends, additional compensation light sources are required, resulting in higher cost or modification to the existing facility, as well as higher maintenance cost.

Thus, it is desired to have an apparatus for measuring line width that overcomes the above problems.

### SUMMARY OF THE INVENTION

The technical issue to be addressed by the present invention is to provide an apparatus for measuring line width, which effectively avoids causing shadows and improves the precision of image capturing of the image capturing device, as well as reduces the number of required light sources to reduce the cost of modification and maintenance of the apparatus for measuring line width.

The present invention provides an apparatus for measuring line width, for capturing an image of a pattern to be measured; the apparatus at least comprises: a first backlight source and a second backlight source, the first backlight source and the second backlight source being disposed respectively under the pattern to be measured and projecting backlight onto the pattern to be measured; an image capturing device, disposed above the pattern to be measured for capturing the image of the pattern; wherein the incident directions of the backlights projected by the first backlight source and the second backlight source forming an angle.

According to a preferred embodiment of the present invention, the width of the orthographic projection of bottom side of the pattern is larger than the width of the orthographic projection of the top side of the pattern.

According to a preferred embodiment of the present invention, the cross-section of the pattern has a trapezoid shape.

According to a preferred embodiment of the present invention, the incident directions of the backlight devices are perpendicular to the bottom side of the pattern.

According to a preferred embodiment of the present invention, the image capturing device captures an image of the bottom side of the pattern.

According to a preferred embodiment of the present invention, the apparatus for measuring line width further comprises a computer, connected to the image capturing device and receiving image captured by the image capturing device.

According to a preferred embodiment of the present invention, the first backlight source is an LED, cold cathode fluorescent lamp or incandescent light.

According to a preferred embodiment of the present invention, the second backlight source is an LED, cold cathode fluorescent lamp or incandescent light.

According to a preferred embodiment of the present invention, the pattern to be measured is a transparent electrode layer on a liquid crystal glass or a black matrix layer on a color filter film.

According to a preferred embodiment of the present invention, the image capturing device captures an image of the bottom side of the pattern.

The present invention provides an apparatus for measuring line width, for capturing an image of a pattern to be measured; the apparatus at least comprises: a first backlight source and a second backlight source, the first backlight source and the second backlight source being disposed respectively under the pattern to be measured and projecting backlight onto the pattern to be measured; an image capturing device, disposed above the pattern to be measured for capturing the image of the pattern.

According to a preferred embodiment of the present invention, the image capturing device captures an image of the bottom side of the pattern.

According to a preferred embodiment of the present invention, the incident directions of the backlights projected by the first backlight source and the second backlight source form an angle.

According to a preferred embodiment of the present invention, the width of the orthographic projection of bottom side of the pattern is larger than the width of the orthographic projection of the top side of the pattern.

According to a preferred embodiment of the present invention, the cross-section of the pattern has a trapezoid shape.

According to a preferred embodiment of the present invention, the incident directions of the backlight devices are perpendicular to the bottom side of the pattern.

According to a preferred embodiment of the present invention, the apparatus for measuring line width further comprises a computer, connected to the image capturing device and receiving image captured by the image capturing device.

According to a preferred embodiment of the present invention, the first backlight source is an LED, cold cathode fluorescent lamp or incandescent light.

According to a preferred embodiment of the present invention, the second backlight source is an LED, cold cathode fluorescent lamp or incandescent light.

According to a preferred embodiment of the present invention, the pattern to be measured is a transparent electrode layer on a liquid crystal glass or a black matrix layer on a color filter film.

The efficacy of the present invention is that to be distinguished from the state of the art. Through disposing backlighting first backlight source and second backlight source, the present invention provides a large lighting range and avoids causing shadow at the edge of the pattern. As such, the present invention effectively avoids causing shadows and improves the precision of image capturing of the image capturing device, as well as reduces the number of required light sources to reduce the cost of modification and maintenance of the apparatus for measuring line width.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing line width measurement in a known technique;

FIG. 2 is a schematic view showing the image integral of the edge of the pattern by a line width measurement apparatus in a known technique;

FIG. 3 is a schematic view showing the structure of a first embodiment of the apparatus for measuring line width according to the present invention; and

FIG. 4 is a schematic view showing the structure of a second embodiment of the apparatus for measuring line width according to the present invention.

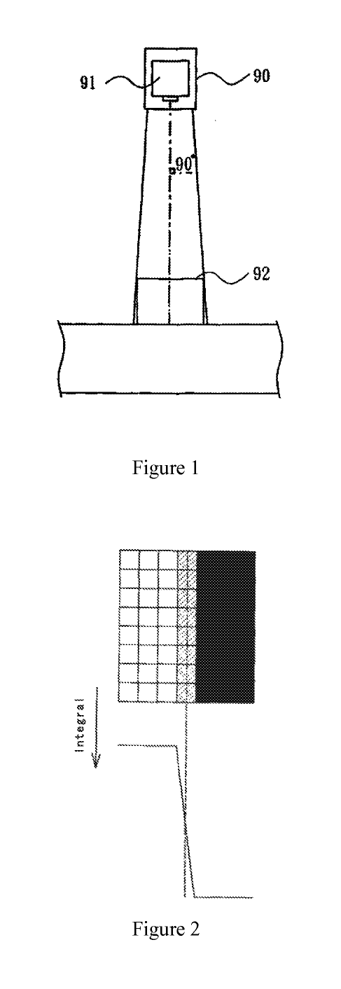

### DETAILED DESCRIPTION OF THE PREFERRED EMBODIMENTS

The following refers to drawings to describe the preferred embodiments of the present invention.

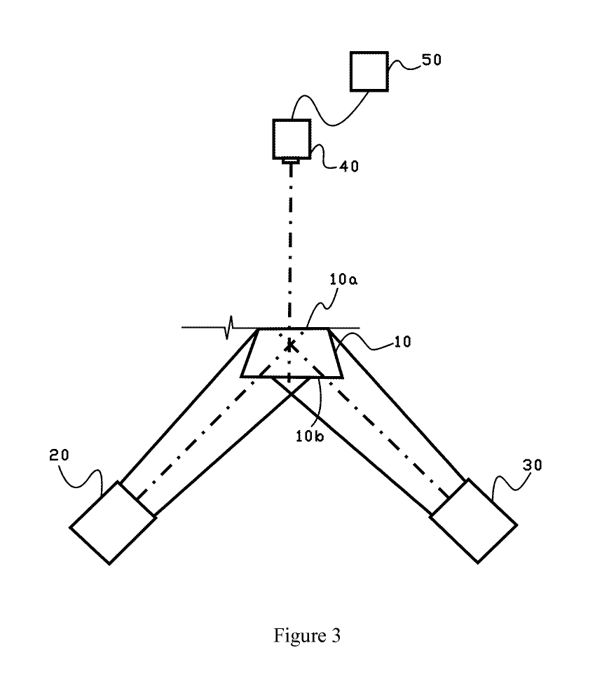

Referring to FIG. 3, FIG. 3 is a schematic view showing the structure of the first embodiment of the apparatus for measuring line width according to the present invention.

The apparatus for measuring line width in the instant embodiment comprises: a pattern 10 to be measured, a first backlight source 20, a second backlight source 30 and an image capturing device 40.

In the instant embodiment, the pattern 10 to be measured mainly refers to patterns having related elements of liquid crystal display (LCD), such as, an ITO transparent electrode layer on a liquid crystal glass or a black matrix (BM) layer on a color filter film.

In the instant embodiment, the cross-section of the pattern 10 has a trapezoid shape. The width of the orthographic projection of bottom side 10b of the pattern is larger than the width of the orthographic projection of the top side 10a of the pattern. Because the pattern 10 with the trapezoidal cross-section has a bottom side 10b larger than the top side 10a, a front light source for capturing image will at least require a main light source to cover the bottom side 10b and two compensation light sources to achieve precise capturing. However, the present embodiment only requires two light sources to achieve the same result.

The first backlight source 20 and the second backlight source 30 are disposed respectively under the pattern 10 to be measured and project backlight onto the pattern 10, wherein the first backlight source 20 and the second backlight source 30 are located respectively on two sides of the pattern 10 and keeps a distance from the pattern 10. The incident directions of the two backlights projected by the first backlight source and the second backlight source form an angle so that the light area of the backlight sources can cover the entire bottom side 10b of the pattern 10.

Furthermore, the first backlight source 20 can be an LED, cold cathode fluorescent lamp (CCFL) or incandescent light. The second backlight source 20 can be an LED, cold cathode fluorescent lamp (CCFL) or incandescent light.

Preferably, the incident directions of the first backlight source 20 and the second backlight source 30 form a slant angle with the bottom side 10b of the pattern 10. The slant angle is preferably between 30° and 60°, in particular 45°.

The image capturing device 40 is disposed above the top side 10a of the pattern 10 and faces the top side 10a of the pattern 10.

In the instant embodiment, because the first backlight source 20 and the second backlight source 30 provide backlighting, the incident lights of the two light sources can cover the entire bottom side 10b and the area between the top side 10a and bottom side 10b of the pattern 10. As such, the image capturing device 40 can capture images respectively from the top side 10a and bottom side 10b of the pattern 10.

Preferably, the apparatus for measuring line width further comprises a computer 50, connected to the image capturing device 40 and receiving image captured by the image capturing device 40.

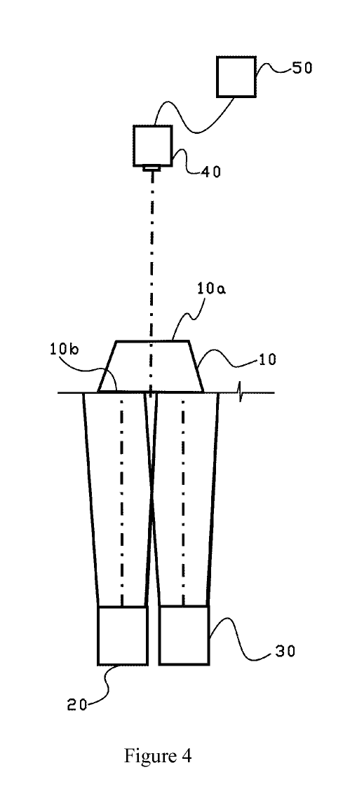

Referring to FIG. 4, FIG. 4 is a schematic view showing the structure of the second embodiment of the apparatus for measuring line width according to the present invention.

Because the second embodiment of the apparatus for measuring line width according to the present invention is similar to the first embodiment of the apparatus for measuring line width according to the present invention, the element names and labels are the same. The difference is that the incident directions of the first backlight source 20 and the second backlight source 30 are perpendicular to the bottom side 10b of the pattern 10, which can still provide lighting to edge of the bottom side 10b of the pattern 10.

Through disposing backlight source, the apparatus for measuring line width of the present invention can provide a larger lighting range and avoid causing shadow at the edge of the pattern 10.

In summary, compared to the known technique of using a main light source and a plurality of compensation light sources to capture image of the pattern more accurately, the present invention disposes backlight sources to provide a larger lighting range and avoid causing shadow at the edge of the pattern. As such, the present invention effectively avoids causing shadows and improves the precision of image capturing of the image capturing device, as well as reduces the number of required light sources to reduce the cost of modification and maintenance of the apparatus for measuring line width.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. An apparatus for measuring line width, for capturing an image of a pattern to be measured; the apparatus at least comprises:
a first backlight source and a second backlight source, the first backlight source and the second backlight source being disposed respectively under the pattern to be measured and projecting backlight onto the pattern to be measured; and
an image capturing device, disposed above the pattern to be measured for capturing the image of the pattern;
wherein the incident directions of the backlights projected by the first backlight source and the second backlight source forming an angle.

2. The apparatus for measuring line width as claimed in claim 1, characterized in that the width of the orthographic projection of bottom side of the pattern is larger than the width of the orthographic projection of the top side of the pattern.

3. The apparatus for measuring line width as claimed in claim 2, characterized in that the cross-section of the pattern has a trapezoid shape.

4. The apparatus for measuring line width as claimed in claim 1, characterized in that the incident directions of the backlight devices are perpendicular to the bottom side of the pattern.

5. The apparatus for measuring line width as claimed in claim 4, characterized in that the image capturing device captures an image of the bottom side of the pattern.

6. The apparatus for measuring line width as claimed in claim 1, characterized in that the apparatus for measuring line width further comprises a computer, connected to the image capturing device and receiving image captured by the image capturing device.

7. The apparatus for measuring line width as claimed in claim 1, characterized in that the first backlight source is an LED, cold cathode fluorescent lamp or incandescent light.

8. The apparatus for measuring line width as claimed in claim 1, characterized in that the second backlight source is an LED, cold cathode fluorescent lamp or incandescent light.

9. The apparatus for measuring line width as claimed in claim 1, characterized in that the pattern to be measured is a transparent electrode layer on a liquid crystal glass or a black matrix layer on a color filter film.

10. The apparatus for measuring line width as claimed in claim 9, characterized in that the image capturing device captures an image of the bottom side of the pattern.

11. An apparatus for measuring line width, for capturing an image of a pattern to be measured; the apparatus at least comprises:
a first backlight source and a second backlight source, the first backlight source and the second backlight source being disposed respectively under the pattern to be measured and projecting backlight onto the pattern to be measured; and
an image capturing device, disposed above the pattern to be measured for capturing the image of the pattern.

12. The apparatus for measuring line width as claimed in claim 11, characterized in that the image capturing device captures an image of the bottom side of the pattern.

13. The apparatus for measuring line width as claimed in claim 12, characterized in that he incident directions of the backlights projected by the first backlight source and the second backlight source form an angle.

14. The apparatus for measuring line width as claimed in claim 13, characterized in that the width of the orthographic projection of bottom side of the pattern is larger than the width of the orthographic projection of the top side of the pattern.

15. The apparatus for measuring line width as claimed in claim 14, characterized in that the cross-section of the pattern has a trapezoid shape.

16. The apparatus for measuring line width as claimed in claim 11, characterized in that the incident directions of the backlight devices are perpendicular to the bottom side of the pattern.

17. The apparatus for measuring line width as claimed in claim 11, characterized in that the apparatus for measuring line width further comprises a computer, connected to the image capturing device and receiving image captured by the image capturing device.

18. The apparatus for measuring line width as claimed in claim 11, characterized in that the first backlight source is an LED, cold cathode fluorescent lamp or incandescent light.

19. The apparatus for measuring line width as claimed in claim 11, characterized in that the second backlight source is an LED, cold cathode fluorescent lamp or incandescent light.

20. The apparatus for measuring line width as claimed in claim 11, characterized in that the pattern to be measured is a transparent electrode layer on a liquid crystal glass or a black matrix layer on a color filter film.
